(19) United States
(12) Patent Application Publication
(10) Pub. No.: US 2010/0227255 A1
(43) Pub. Date: Sep. 9, 2010

(54) Cell module for fuel cell, method for forming cell module, and fuel cell

(75) Inventors: Haruyuki Nakanishi, Susono-shi (JP); Shigeaki Murata, Numazu-shi (JP); Nobuhira Abe, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/639,133

(22) Filed: Dec. 15, 2006

(30) Foreign Application Priority Data
Jun. 11, 2004 (JP) 2004-174746

(51) Int. Cl. H01M 8/10; H01M 8/00

(52) U.S. Cl. 429/497; 429/535

(57) ABSTRACT

A cell module for a fuel cell according to embodiments of the invention includes a hollow-core electrolyte membrane; and two electrodes one of which is arranged on the inner face of the hollow-core electrolyte membrane and the other of which is arranged on the outer face of the hollow-core electrolyte membrane. At least one of the two electrodes includes nano-columnar bodies, which are oriented toward the hollow-core electrolyte membrane, and on which electrode catalysts are supported.

### BACKGROUND OF THE INVENTION

1. Field of the Invention

The invention relates generally to a cell module suitable as an electric power generation portion of a fuel cell, and, more specifically, to a cell module including a hollow-core electrolyte membrane. The invention also relates to a method for forming such cell module, and a fuel cell in which such cell module is used as a cell.

2. Description of the Related Art

In fuel cells, fuel and an oxidant are supplied to two respective electrodes electrically connected to each other, and the fuel is electrochemically oxidized, whereby chemical energy is directly converted into electric energy:—Unlike thermal electric power generation, electric power generation by the fuel cells is not restricted by the Carnot cycle. Accordingly, the fuel cells exhibit high energy conversion efficiency. In polymer electrolyte fuel cells, polymer electrolyte membranes are used as electrolytes. Attention has been given to the polymer electrolyte fuel cells, particularly, as mobile electric power sources and electric power sources for movable bodies, due to their advantages that it is easy to downsize such polymer electrolyte fuel cells, the polymer electrolyte fuel cells operate at a low temperature, etc.

In the polymer electrolyte fuel cells, when hydrogen is used as fuel, the reaction indicated by the following equation (1) proceeds at the anode.

H₂→2H⁺+2e⁻ (1)

The electrons generated by the reaction indicated by the equation (1) flow through an external circuit, work as electricity using an external load, and then reach the cathode. The protons generated by the reaction indicated by the equation (1) flow, while being hydrated with water, from the anode side to the cathode side through the polymer electrolyte membrane by electro-osmosis.

When oxygen is used as an oxidant, the reaction indicated by the equation (2) proceeds at the cathode.

2H⁺+(1/2)O₂+2e⁻H₂O (2)

The water generated at the cathode passes mainly through gas diffusion layers, and is then discharged to the outside of the fuel cell. As just described, the fuel cells are clean electric power generators that discharge only water.

Polymer electrolyte fuel cells including fuel cell stacks formed in the following manner have been mainly developed. Such fuel cell stacks are formed in the manner in which (i) a catalytic layer used as the anode is formed on one face of a flat polymer electrolyte membrane, and another catalytic layer used as the cathode is formed on the other face of the flat polymer electrolyte membrane, (ii) gas diffusion layers are formed on the respective sides of the flat membrane-electrode-assembly, and (iii) multiple flat cells, each of which is formed by arranging the membrane-electrode-assembly with the gas diffusion layers between flat separators, are stacked on top of each other.

Considerably thin proton-conducting polymer membranes are used as the polymer electrolyte membranes in order to increase the power density of the polymer electrolyte fuel cells. The proton-conducting polymer membranes having a thickness of equal to or less than 100 μm are mainly used. Even if thinner electrolyte membranes are used to further increase the power density, it is not possible to form cells that are drastically thinner than the commonly used cells. Similarly, the thickness of each of catalytic layers, gas diffusion layers, separators, etc, has been reduced. However, there is a limit to increases, due to reduction in the thickness of such members, in the power density per unit volume. For such reason, it may be difficult to meet the demand for more compact fuel cells.

In addition, there is a disadvantage that the production cost of fuel cells is high. Usually, sheet-like carbon materials having excellent corrosion resistance are used to form the separators. However, the carbon materials are expensive. In addition, grooves that serve as gas passages are usually microfabricated in the faces of the separators in order to substantially uniformly distribute fuel gas and oxidant gas to the entire faces of the flat membrane-electrode-assembly. Microfabricating such grooves makes the separators considerably expensive. This drastically increases the production cost of the fuel cells.

The above described fuel cells have many other disadvantages. For example, it is technically difficult to reliably provide sealing to the periphery of each of the multiple cells stacked on top of each other in order to prevent the fuel gas and the oxidant gas from leaking from the gas passages. Further, the electric power generation efficiency may be reduced due to deflection or deformation of the flat membrane-electrode-assemblies.

In recent years, polymer electrolyte fuel cells, in which a cell module formed by arranging electrodes on the inner side and the outer side, respectively, of a hollow-core electrolyte membrane is used as a basic unit of electric power generation, have been developed. Such technology is described, for example, in Japanese Patent Application Publication No. JP-A-09-223507 (Document 1), Japanese Patent Application Publication No. JP-A-2002-158015 (Document 2), Japanese Patent Application Publication No. JP-A-2002-260685 (Document 3), Japanese Patent Application Publication No. JP-A-2002-289220 (Document 4), and Japanese Patent Application Publication No. JP-A-2002-124273 (Document 5).

In the fuel cells including such hollow-core cell modules, members corresponding to the separators used in the flat cell modules are usually not required. In addition, the gas passages need not be formed, because different types of gases are supplied to the inner faces and the outer faces of the cell modules, respectively, to generate electric power. Accordingly, the production cost may be reduced. In addition, because the cell module has a three-dimensional shape, the specific surface area of the hollow-core cell module is greater than that of the flat cell module, which may increase the power density of electric power generation per unit volume.

It is considered that the electrode reaction occurs at a portion, at which an electrode catalyst contacts a proton-conducting substance and to which the reaction gas is supplied, namely, a three-phase interface. Accordingly, increasing the power density of the fuel cells by controlling the three-phase interface has been examined. However, under the present circumstances, it is difficult to appropriately design the three-phase interface. For example, the electrode catalysts may sink down into the proton-conducting substance, which interrupts a supply of the reaction gas. On the other hand, if the electrode catalysts are arranged at positions apart from the proton-conducting substance, a supply of protons from the proton-conducting substance or a supply of protons to the proton-conducting substance may be interrupted. Due to such inconveniences, the expensive catalysts made of noble metal are not effectively used.

Also, the electrons generated by the electrode reaction at the three-phase interface on the anode side pass through collecting member, reach the three-phase interface on the cathode side, and are used for the electrode reaction that occurs on the cathode side. Therefore, it is necessary to maintain good conduction of electricity between the electrolyte membrane and the collecting members. In order to provide conduction of electricity to the cell stack formed of the flat cells, usually, the cells are stacked on top of each other, and pressed to each other by applying relatively strong pressure. The applied pressure causes the membrane-electrode-assembly to closely contact the gas diffusion layers and the separators, thereby providing conduction of electricity.

The hollow-core cell modules lack the separators, which serve as the collecting members in the flat cells and which electrically connect the cells. Accordingly, the hollow-core cell modules require collecting members.

Document 1 describes using titanium (Ti) wires as the collecting members, and fitting the titanium wires to the electrodes that support platinum (Pt). Document 2 describes electrically connecting the ends of column-shaped electrochemical elements to each other by a conductive connecting pattern. Document 3 describes using external terminals connected to the catalytic layers as collecting members in tubular fuel cells. Document 4 describes connecting collecting electrodes to catalytic layers by lead wires. Document 5 describes installation of linear negative terminals and linear positive terminals.

As described above, it is difficult to perform design so that the three-phase interface is controlled to effectively use the electrode catalysts. In the hollow-core cell modules, it is also difficult to perform design so that the three-phase interface is controlled to effectively use the electrode catalysts.

Unlike the flat cell modules, in the hollow-core cell modules, it is difficult, due to the shape and the structure, to apply surface pressure for causing the electrodes and the collecting members to contact more closely. Accordingly, conduction of electricity is likely to be insufficient.

When wires are used as the collecting members as described in the patent publications described above, the contact area between the electrodes and the collecting members is small. Accordingly, conduction of electricity is more likely to be insufficient due to insufficient surface pressure.

### SUMMARY OF THE INVENTION

A first aspect of the invention relates to a cell module for a fuel cell, which includes a hollow-core electrolyte membrane; and two electrodes one of which is arranged on the inner face of the hollow-core electrolyte membrane and the other of which is arranged on the outer face of the hollow-core electrolyte membrane. At least one of the two electrodes includes nano-columnar bodies, which are oriented toward the hollow-core electrolyte membrane, and on which electrode catalysts are supported.

In this structure, the electrode catalytic metal particles are supported on the nano-columnar bodies arranged on the hollow-core electrolyte membrane. Accordingly, the electrode catalysts are highly densely supported on the nano-columnar bodies. Also, the electrode reaction occurs at a portion, at which an electrode catalyst contacts a proton-conducting substance and to which the reaction gas is supplied, namely, a three-phase interface. In the cell module according to the first aspect of the invention, because the electrode is formed by arranging the nano-columnar bodies, on which the electrode catalysts are supported, on the hollow-core electrolyte membrane, the reaction gas supplied for the electric power generation easily comes close to the three-phase the three-phase interface to be uniformly dispersed. Accordingly, the electrode catalysts supported on the nano-columnar bodies are efficiently used for the electrode reaction.

A second aspect of the invention relates to a fuel cell including the cell module according to the first aspect of the invention.

A third aspect of the invention relates to a method for forming a cell module for a fuel cell. In the method, electrode catalysts are caused to be supported on nano-columnar bodies formed on a nanotube forming catalyst supporting body. Further, the nano-columnar bodies, on which the electrode catalysts are supported, are transferred to at least one of the inner face and the outer face of a hollow-core electrolyte membrane, and the nano-columnar bodies are arranged so that the nano-columnar bodies are bonded, at one ends, to the face of the hollow-core electrolyte membrane.

According to such method, the reaction gas easily reaches the electrode catalysts densely supported on the electrodes and the three-phase interface located near the electrode catalysts. Accordingly, the electrode catalysts supported on the nano-columnar bodies are efficiently used for the electrode reaction, and high electric power generation efficiency is exhibited.

In cell module according to the invention, the nano-columnar bodies, on which the catalysts are supported, are arranged on the hollow-core electrolyte membrane so that the nano-columnar bodies are bonded, at one ends, to the hollow-core electrolyte membrane. The nano-columnar bodies efficiently contact, at the other end, the collecting member. Accordingly, electric charges are smoothly exchanged between the electrode and the collecting member/the hollow-core electrolyte membrane. Therefore, even in a cell module including a hollow-core electrolyte membrane with which it is difficult to apply an external surface pressure between the collecting member and the cell module, appropriate electric connection is maintained between the cell module and the collecting member. Therefore, the cell module including the hollow-core electrolyte membrane according to the invention exhibits high electric power generation efficiency. The fuel cell formed by gathering the cell modules has excellent electric power generation efficiency.

### BRIEF DESCRIPTION OF THE DRAWINGS

The forgoing and/or further objects, features and advantages of the invention will become more apparent from the following description of example embodiments with reference to the accompanying drawings, wherein the same or corresponding portions will be denoted by the same reference numerals and wherein:

FIG. 1 is the perspective view schematically showing a tubular cell module and spring wires (collecting members) fitted to the tubular cell module according to a first embodiment of the invention;

FIG. 2 is the cross-sectional view of the tubular cell module and the spring wires fitted to the tubular cell module according to the first embodiment of the invention, which is obtained when the tubular cell module and the spring wires are cut by a plane extending in the longitudinal direction of the cell module;

FIG. 3 is the enlarged view of the area A surrounded by the dot line in FIG. 2;

FIG. 4 is the view schematically showing a fuel cell formed by gathering the cell modules with collecting members;

FIG. 5 is the cross-sectional view of a tubular cell module and spring wires fitted to the tubular cell module according to a second embodiment of the invention, which is obtained when the tubular cell module and the spring wires are cut by a plane extending in the longitudinal direction of the cell module;

FIG. 6 is the enlarged view of the area B surrounded by the dot line in FIG. 5;

FIG. 7 is the cross sectional view of a cell module according to a first modified example of the embodiments of the invention; and

FIG. 8 is the cross sectional view of a cell module according to a second modified example of the embodiments of the invention.

### DETAILED DESCRIPTION OF THE EXAMPLE EMBODIMENTS

In the following description, the invention will be described in more detail in terms of example embodiments.

Hereafter, cell modules for a fuel cell according to the embodiments of the invention, and fuel cells including such cell modules will be described with reference to accompanying drawings. In addition, methods for forming the cell modules according to the embodiments of the invention will be described. In the embodiments of the invention, a polymer electrolyte fuel cell, in which hydrogen gas serving as fuel, and air (oxygen) are used for generation operation, will be mainly described. However, the invention is not limited to the embodiments described below.

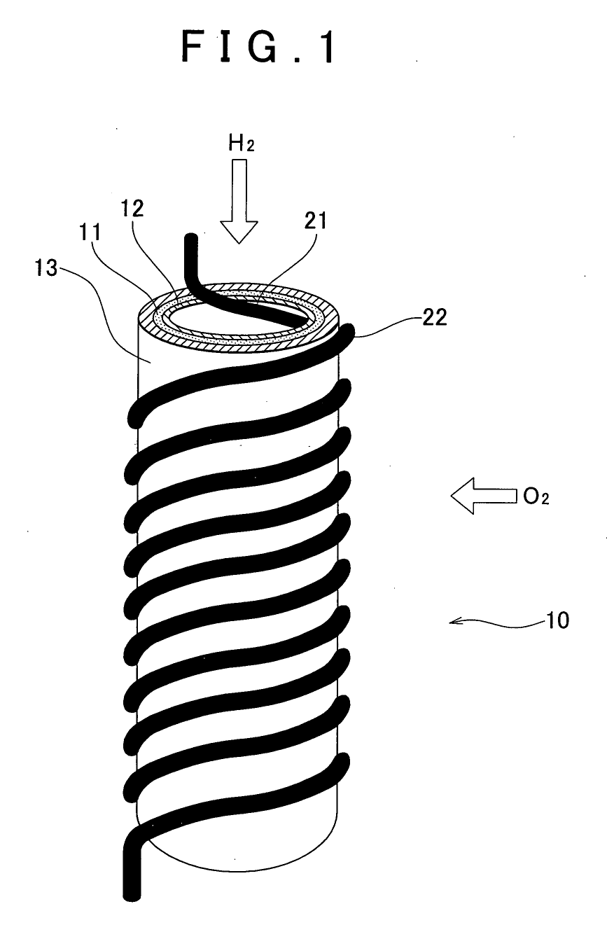

A cell module according to a first embodiment of the invention, and a fuel cell including such cell module will be described with reference to FIGS. 1 to 4. The cell module according to the first embodiment of the invention is formed by bonding carbon nanotubes (hereinafter, sometimes referred to as “CNT”), on which platinum (Pt; electrode catalytic metal) are supported, onto the inner face and the outer face of a tubular fluorine ion-exchange resin membrane (a polymer electrolyte membrane) so that orientation of the carbon nanotubes is appropriately maintained, and then arranging spring wires, which serve as collecting members, on the inner side and the outer side of the tubular fluorine ion-exchange resin membrane, respectively. The carbon nanotube is one type of nano-columnar bodies.

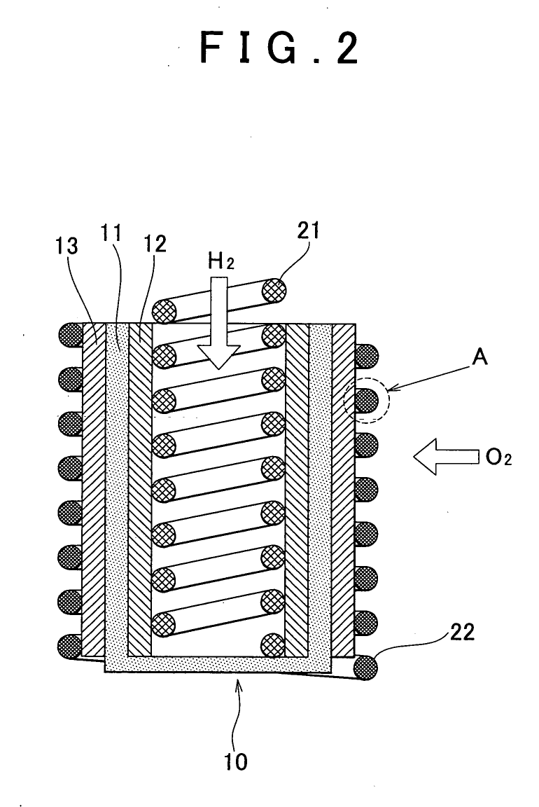

FIG. 1 is the perspective view of a tubular cell module 10 and spring wires (collecting members) 21, 22 fitted to the cell module 10 according to the first embodiment of the invention. FIG. 2 is the cross sectional view of the cell module 10 and the spring wires 21, 22. As shown in FIGS. 1 and 2, the cell module 10 is formed of a tubular fluoride ion-exchange resin membrane 11; an anode (a fuel electrode) 12 arranged on the inner face of the fluorine ion-exchange resin membrane 11, and a cathode (an oxidant electrode) 13 arranged on the outer face of the fluorine ion-exchange resin membrane 11. In the specification, the anode 12 and the cathode 13 will be sometimes collectively referred to as the “CNT electrodes”. The anode-side collecting member 21, formed of a spring wire, is arranged on the inner side of the cell module 10, and the cathode-side collecting member 22, formed of another spring wire, is arranged on the outer side of the cell module 10.

The electrolyte membrane, which is the main component of the cell module 10 according to the invention, has a hollow-core shape. In the first embodiment of the invention, the tubular electrolyte membrane is employed. Using the hollow-core electrolyte membrane offers various advantages. The significant advantages are that the separators are not required, and the electrode area, which is used for electric power generation, is large

Although not limited to certain values, the outer diameter of the tubular electrolyte membrane 11 is preferably 0.01 mm to 10 mm, more preferably 0.1 mm to 1 mm, and optimally 0.1 mm to 0.5 mm. Under the present circumstances, it is technically difficult to form the tubular electrolyte membrane 11 having an outer diameter of less than 0.01 mm. However, if the outer diameter of the tubular electrolyte membrane 11 exceeds 10 mm, the surface area with respect to the occupied volume is not sufficient. Accordingly, the effects of increasing the power output per unit volume of the cell module may not be sufficiently produced.

Preferably, the fluorine ion-exchange resin membrane 11 is thin, from the viewpoint of enhancement of proton-conductivity. However, if the fluorine ion-exchange resin membrane 11 is excessively thin, the function of separating gases decreases, resulting in increases in the amount of aprotic hydrogen that permeates through the fluorine ion-exchange resin membrane 11. However, in the fuel cell formed of the hollow-core cell modules 10 according to the first embodiment of the invention, a large electrode area used for electric power generation is obtained. Accordingly, even if a rather thick membrane is used, the fuel cell according to the first embodiment of the invention produces sufficient output, as compared to the fuel cells, according to the related art described above, formed by stacking the flat cells on top of each other. From such viewpoint, the thickness of the fluorine ion-exchange resin membrane 11 is usually 10 μm to 100 μm, preferably 50 μm to 60 μm, and more preferably 50 μm to 55 μm.

Based on the preferable outer diameter and thickness of the fluorine ion-exchange resin membrane 11, the inner diameter of the fluorine ion-exchange resin membrane 11 is preferably 0.01 mm to 10 mm, more preferably 0.1 mm to 1 mm, and optimally, 0.1 mm to 0.5 mm.

Preferably, the fluorine ion-exchange resin membrane 11 is formed of a polymer having a polyolefin skeleton where part or entire of hydrogen is replaced with fluorine, and has a proton exchange group in a side chain. Examples of preferable proton exchange groups are a sulfonic acid group, a phosphonic acid group, and a phosphate group. Particularly preferable fluorine ion-exchange resin membrane is a perfluorocarbon polymer having a sulfonic acid group (a perfluorocarbon sulfonic acid polymer). Commercially available polymers such as Nafion produced by DuPont or Flemion produced by Asahi Glass Co., Ltd may be used as the perfluorocarbon sulfonic acid polymer.

Preferably, the weight-average molecular weight of the polymer forming the fluorine ion-exchange resin membrane 11 is 5000 or greater, from the viewpoint of durability.

Because the cell module 10 according to the first embodiment of the invention is hollow, the specific surface area is greater than that of a flat cell. Accordingly, even if a solid electrolyte membrane having a proton-conductivity lower than that of the fluorine ion-exchange resin membrane is used as the hollow-core electrolyte membrane 11, it is possible to produce a fuel cell having a high power density per unit volume. Therefore, any types of solid electrolyte membranes having proton-conductivity may be used as the hollow-core electrolyte membrane 11. For example, when the invention is applied to a solid oxide fuel cell or a polymer electrolyte fuel cell in which hydroxide ions are used as the charge carriers, a solid electrolyte membrane, through which other ions such as oxygen ions or hydroxide ions that serve as charge carriers pass, may be used as the hollow-core electrolyte membrane 11.

Examples of solid electrolyte membranes having proton-conductivity will be described below. An example of the solid electrolyte membrane, in which carbon hydride such as polyolefin is used as a skeleton and which contains at least one of proton exchange groups such as the sulfonic acid group, the phosphonic acid group, and the phosphate group, is a polystyrene cation exchange membrane containing the sulfonic acid group. Another example of the solid electrolyte membrane is a solid polymer electrolyte membrane formed of a complex of a strong acid with a basic polymer, formed by doping a basic polymer such as polybenzimidazole, polypyrimidine, or polybenzoxazole with a strong acid. Such solid polymer electrolyte membrane is described, for example, in Japanese Patent Application Publication No. JP-A-11-503262. Other examples include inorganic proton conductors such as hydrogelated phosphate glass described in page 69, No. 3, Vol. 3 of “Fuel Cell” written by Toshihiro Kasuga (issued in 2004). An organic-inorganic hybrid solid electrolyte membrane, to which proton-conductivity is imparted by introducing organic compounds in the pores of porous glass, may be used. This organic-inorganic hybrid solid electrolyte membrane is described in page 41, No. 1, Vol. 57 of “Chemistry and Industry” written by Takaharu Fujioka, Takashi Kikukawa, and Tetsuo Yazawa (issued in 2004).

Preferably, pores, that serve as the passages through which ions flow, are formed in the fluorine ion-exchange resin membrane and the solid electrolyte membrane which is used instead of the fluorine ion-exchange resin membrane when appropriate. A hydrophilic cluster region and a hydrophobic skeleton region are formed in the fluorine ion-exchange resin membrane 11. Fine pores are formed in the cluster region. The average pore diameter of the pores formed in the solid electrolyte membrane is, preferably 5 nm to 100 nm, more preferably 5 nm to 40 nm, and optimally 5 nm to 10 nm. The pore volume of each pore is 0.1 cm² to 0.5 cm² per gram (0.1 cm²/g to 0.5 cm²/g), and preferably 0.2 cm² to 0.3 cm² per gram (0.2 cm²/g to 0.3 cm²/g). The average pore diameter and/or the pore volume of the pores formed in the fluorine ion-exchange resin membrane 11 are/is controlled, for example, by changing the ratio between monomer units containing hydrophilic radicals and hydrophobic monomer units, or changing alignment of the monomer units in macromolecular chains. The pores having an average pore diameter in the above-mentioned range prevent hydrogen molecules from permeating through the solid electrolyte membrane while permitting protons to permeate through the solid electrolyte membrane. Accordingly, using the fluorine ion-exchange resin membrane 11 or the solid electrolyte membrane, in which the pores having the size in the above-mentioned ranges are formed, makes it possible to achieve high proton conductivity while preventing cross leak of the fuel gas.

When the solid electrolyte membrane, in which the pores having an average pore diameter in the above-mentioned range are formed, is used, the nanotubes are tightly fitted in the pores and, therefore, fixed in the pores. Accordingly, the nanotubes are more easily bonded to the solid electrolyte membrane while maintaining appropriate orientation.

The anode-side collecting member 21 and the cathode-side collecting member 22 are formed, for example, by winding metal wires into a coil shape. Preferably, the wires are made of at least one type of metal selected from Al, Cu, Fe, Ni, Cr, Ta, Ti, Zr, Sm, In, etc. or an alloy of these metals such as stainless steel. Also, the wires may be coated with Au, Pt, a conductive resin, or the like. Preferably, the wires are made of stainless or titanium because stainless and titanium have particularly excellent corrosion resistance. The size of the wire and the number of turns of the coil formed by the wire are not limited to certain values.

When the anode side collecting 21 is produced, preferably, the outer diameter of the coil forming the anode-side collecting member 21 is made slightly greater than the inner diameter of the tubular fluorine ion-exchange resin membrane 11. When the anode-side collecting member 21 is inserted into the space defined by the fluorine ion-exchange resin membrane 11, the anode-side collecting member 21 contacts the anode 12 while applying a slight pressing force to the anode 12. With such structure, the anode-side collecting member is fixed to the anode 12, and electric connection between the anode-side collecting member 21 and the anode 12 is appropriately maintained.

When the cathode-side collecting member 22 is produced, preferably, the inner diameter of the coil forming the cathode-side collecting member 22 is made slightly less than the outer diameter of the tubular fluorine ion-exchange resin membrane 11. When the cathode-side collecting member 22 is attached to the outer face of the fluorine ion-exchange resin membrane 11, the cathode-side collecting member 22 contacts the cathode 13 while applying a slight pressing force to the cathode 13. With such structure, the cathode-side collecting member 22 is fixed to the anode 13, and electric connection between the cathode-side collecting member 22 and the cathode 13 is appropriately maintained.

In the first embodiment of the invention, the collecting members 21, 22 are in a shape of a spring wire. However, the shape of the collecting members 21, 22 is not limited to this. The collecting members 21, 22 may be in any shapes as long as the collecting members 21, 22 are made of electric conducting material. Accordingly, the shapes of the collecting members 21, 22 may be linear or cylindrical. For example, the collecting members 21, 22 may be formed of linear metal wires or sheet materials such as metal sheets and carbon sheets. Alternatively, the anode-side collecting member 21 may be formed by filling the space inside the tubular cell module with conductive particles so that appropriate air permeability is maintained. Also, the cathode-side collecting member 22 may be formed by filling a casing (not shown) arranged outer side of the cell module with conductive particles.

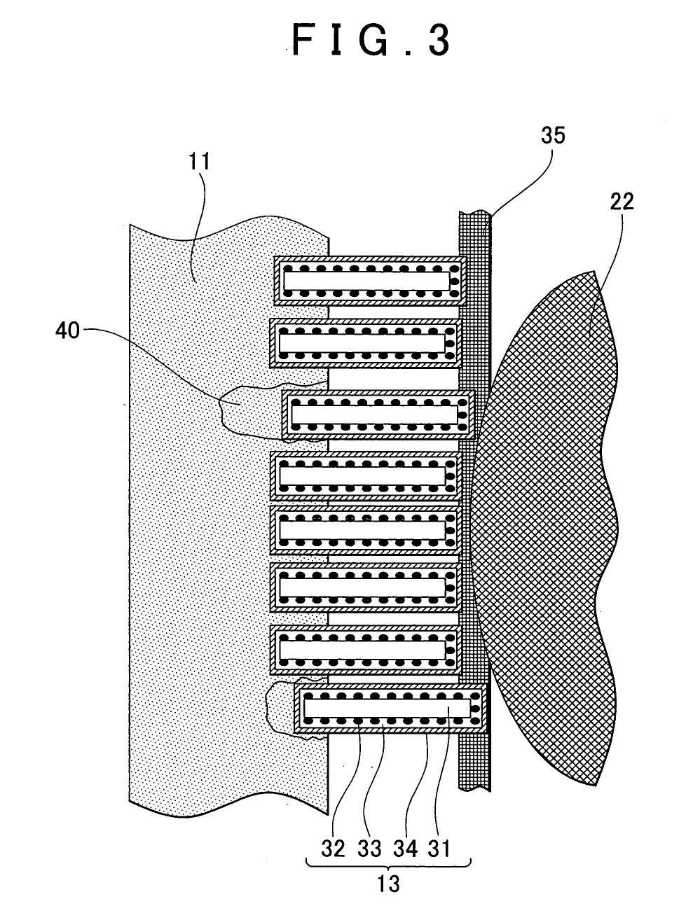

FIG. 3 is the enlarged view of the area A surrounded by the dot line in FIG. 2. The microscopic structure of the cathode 13 and electric connection between the cathode 13 and the cathode-side collecting member 22 will be described with reference to FIG. 3. The microscopic structure of the cathode 13 is substantially the same as that of the anode 12, and electric connection between the cathode 13 and the cathode-side collecting member 22 is substantially the same as that between the anode 12 and the anode-side collecting member 21. Accordingly, the descriptions concerning the microscopic structure of the anode 12 and the electric connection between the anode 12 and the anode-side collecting member 21 will not be provided below.

As shown in FIG. 3, carbon nanotubes 31, each of which has the length of approximately 500 μm and the outer diameter of approximately 10 nm, are oriented toward the fluorine ion-exchange resin membrane 11. The carbon nanotubes 31 are connected, at one ends, to the fluorine ion-exchange resin membrane 11. Part of the carbon nanotubes 31 stick out of or just contact the fluorine ion-exchange resin membrane 11. The other carbon nanotubes 31 fit in pores, each of which has a diameter of 5 nm to 10 nm, formed in the fluorine ion-exchange resin membrane 11. The carbon nanotubes 31, which sink down into the pores 40, are strongly connected, at one ends, to the fluorine ion-exchange resin membrane 11, and support the carbon nanotubes 31 that just contact the fluorine ion-exchange resin membrane 11, whereby the alignment and orientation of the carbon nanotubes 31 are stably maintained.

Preferably, the length of each carbon nanotube 31 is equal to or longer than 200 μm. If the length of the carbon nanotube 31 is shorter than 200 μm, the distance between the fluorine ion-exchange resin membrane 11 and the collecting members 21, 22 is insufficient. Accordingly, the supply amount and the dispersion amount of reaction gas components may be reduced, resulting in reduction in the electric power generation efficiency.

In the first embodiment of the invention, the carbon nanotubes (CNT) 31 are used as the nano-columnar bodies. However, the nano-columnar bodies are not limited to the carbon nanotubes 31. For example, substance, which has a long and thin minute structure and a nano-size diameter, such as nano-glass may be used as the nano-columnar body. Usually, the average diameter ((longest diameter+shortest diameter)/2)) of the nano-columnar body is equal to or less than 100 nm and the aspect ratio of the average diameter is equal to or greater than 10. Especially, it is preferable that the average diameter be 10 nm to 50 nm, and the aspect ratio of the average diameter be equal to or greater than 100. If catalysts are supported on the nano-columnar body having a nano-sized diameter, a great amount of catalysts is supported on the surface of the nano-columnar body. In addition, according to the first embodiment of the invention, the nano-columnar bodies are oriented toward the hollow-core electrolyte membrane 11. Accordingly, each of the nano-columnar bodies does not entirely bury in the hollow-core electrolyte membrane 11, and, consequently, a large catalyst surface used for electrode reaction is obtained. Examples of such nano-columnar bodies include single or multi layer carbon nanotubes or carbon nanohorns, glass nano-columnar bodies, ceramic nano-columnar bodies, metal nano-columnar bodies, and polymer nano-columnar bodies. It is preferable to use the single or multi layer carbon nanotubes or carbon nanohorns, because they have high electric conductivity. It is particularly preferable to use the nanotubes such as carbon nanotubes.

The carbon nanotubes 31 may be synthesized by known synthesis methods such as the arc discharge method; the laser evaporation method; the CVD method in which catalytic metal for forming carbon nanotubes (hereinafter, referred to as “CNT forming catalytic metal”) is used, and the carbon nanotubes are synthesized, for example, by supplying hydrocarbon gas or hydrogen gas to the CNT forming catalytic metal; or the HiPco method in which the carbon nanotubes are synthesized by causing a disproportionation reaction of carbon monoxide under the condition where the temperature and the pressure are high (CO+CO→C+CO₂) (refer, for example, to P. Nikolaev, M. J. Bronikowski, R. K. Bradley, F. Rohmund, D. T. Colbert, K. A. Smith, R. E. Smalley, Chem. Phys. Lett. 313 (1999) 91-97).

As electrode catalytic metal particles 32 that cause the cell reaction, platinum (Pt) particles having an average grain diameter of 2 nm are supported on the surfaces of the carbon nanotubes 31. Using the linear carbon nanotubes 31 as the carries makes it possible to obtain a large surface area and to highly densely support the electrode catalytic metal particles 32. In addition, even under the condition where water is excessively produced during electric power generation, the gas is supplied to the three-phase interface and dispersed, and, therefore, a large drop in the voltage (concentration overvoltage) is suppressed.

Preferably, the average grain diameter of the electrode catalytic metal particles 32 is equal to or less than the outer diameter of the carbon nanotube 31. More preferably, the average grain diameter of the electrode catalytic metal particles 32 is 1 nm to 3 nm. If the outer diameter is less than 1 nm, it is difficult to actually form the carbon nanotubes and to offer effects of the catalytic metal. On the other hand, if the outer diameter is greater than 3 nm, the catalytic efficiency is reduced. In a fuel cell made of such electrode catalytic metal particles, it is difficult to obtain high voltage.

The electrode catalytic metal particles 32 according to the first embodiment of the invention are the platinum (Pt) particles. Because the cell module 10 according to the first embodiment of the invention is hollow, the electrode area per unit volume is greater than that of a flat cell. Accordingly, the electrode catalytic metal particles 32 are not limited to the platinum (Pt) particles. Even if catalysts made of material which is less active than platinum (Pt) are used, it is possible to produce a fuel cell having a high power density per unit volume. Any catalytic materials, which have catalysis on the oxidation reaction of hydrogen at the anode (the fuel electrode), or reduction reaction of oxygen at the cathode (the air electrode), may be used. The catalytic material may be selected from metals such as platinum, ruthenium, iridium, rhodium, palladium, osmium, tungsten, lead, iron, chrome, cobalt, nickel, manganese, vanadium, molybdenum, gallium, and aluminum, and alloys formed by combining these metals. Preferably, the catalytic metal is Pt or an alloy of Pt and another metal, for example, Ru.

The platinum (Pt) particles (the electrode catalytic metal particles 32) may be caused to be supported on the surfaces of the carbon nanotubes 31, for example, by using a diluted solution obtained by diluting a platinum chemical containing a chlorophatinic acid or a platinum nitric acid with a solvent, for example, alcohol. This will be described later in detail.

As shown in FIG. 3, Nafion layers 33 are formed on the outer faces of the carbon nanotubes 31 by applying Nafion solution (a proton conducting substance produced by Aldrich Chemical Company, Inc.) onto the outer faces of the carbon nanotubes 31, on which the electrode catalytic metal particles 32 are supported. The Nafion layers 33 serve as the proton-conducting substance, whereby proton-conductivity at the cell reaction and the strength, with which the fluorine ion-exchange resin membrane 11 is connected to the nano-columnar bodies, are sufficiently obtained.

In the first embodiment of the invention, Nafion is used as the proton-conducting substance. However, various types of polymers and inorganic materials having proton conductivity may be used. It is preferable to use a polymer, in which a fluorine-containing polymer is used as a skeleton, and at least one of the proton exchange-groups such as the sulfonic acid group, the phosphonic acid group, and the phosphate group is contained. Alternatively, it is possible to use the material, in which carbon hydride such as polyolefin is used as a skeleton and which contains at least one of proton exchange groups such as the sulfonic acid group, the phosphonic acid group, and the phosphate group, such as a polystyrene cation exchange membrane containing the sulfonic acid group. It is also possible to use a solid polymer electrolyte membrane formed of a complex of a strong acid with a basic polymer, formed by doping a basic polymer such as polybenzimidazole, polypyrimidine, or polybenzoxazole with a strong acid. Such solid polymer electrolyte membrane is described, for example, in Japanese Patent Application Publication No. JP-A-11-503262. Examples of the inorganic materials include sulfonated phosphate silicate glass, boride silicate soda glass, and y-alumina. Particularly preferable proton conducting substances are perfluoro sulfonate polymer such as Nafion, polystyrene sulfonic acid, phosphate silicate glass, boride silicate soda glass, and γ-alumina. The thickness of the Nation layer (the proton-conducting substance) 33 is preferably 1 nm to 70 nm, and more preferably 10 nm to 30 nm. If the thickness of the Nafion layer 33 is less than 1 nm, the protons may not be sufficiently supplied to the electrode catalytic metal particles supported on the carbon nanotubes 31 or the protons may be not be sufficiently supplied from the electrode catalytic metal particles. On the other hand, if the thickness of the Nation layer 33 exceeds 70 nm, the proton-conducting substance excessively covers the carbon nanotubes 31, which may make it difficult to supply gas to the electrode catalytic metal particles supported on the carbon nanotubes 31.

PTFE layers 34 formed of polytetrafluoroethylene (a water-repellent material; PTFE) are further formed on the Nafion layers 33 formed on the carbon nanotubes 31. The PTFE layers 34 serve as water-repellent layers. Forming the PTFE layers 34 makes it possible to reliably discharge the water produced by the cell reaction. The PTFE layers 34 may be formed on at least part of the surfaces of the Nafion layers 33. Also, part of PTFE may enter the Nafion layers 33.

It is preferable to use at least one type of fluorine resin selected from various types of fluorine resins as the water-repellent material. However, the water-repellent material is not limited certain types of materials. As the water-repellent material, for example, polyvinylidene-fluoride (PVDF), polytetrafluoroethylene, perfluoroalkoxyalkane, or ethylene-tetrafluoroethylene polymer may be used. Alternatively, these materials may be used in combination.

The cell module 10 thus formed and the collecting members 21, 22 may be connected to each other by a conductive adhesive agent 35. As the conductive adhesive agent 35, for example, Ag paste is appropriately used.

Hereafter, an example of the method for forming carbon nanotubes will be described. The case where single-layer carbon nanotubes are synthesized using CNT forming catalyst body will be described below.

First, the base body cleaning step is performed, when required. In the base body cleaning step, the surface of a base body (e.g. a substrate), used to form the carbon nanotubes, is cleaned. The surface of the base body is cleaned by heating the substrate, which is the base body, in an electric furnace under vacuum.

Next, the CNT forming catalyst supporting step is performed. More specifically, the CNT forming catalyst supporting body, which is used to form the carbon nanotubes, is formed by causing the CNT forming catalytic metal particles to be supported on the base body. The forming method is not limited to a certain method. For example, the CNT forming catalytic metal such as Fe may be uniformly broken into particles and then the Fe particles may be caused to be supported on the base body, for example, by evaporation coating. Thus, the CNT forming catalyst supporting body may be formed.

Examples of the CNT forming catalytic metal include not only Fe but also Pd, Co, Ni, W, Mo, Mn and alloys of these metals. The base body may be formed, for example, of Al, Ni, stainless, Si, SiC, zeolite or activated carbon (C). The base body for the CNT forming catalysts may have any shapes. When the electrode catalyst layer (the anode or the cathode) is formed in the space defined by the hollow-core electrolyte membrane, it is preferable to use, as the base body for the CNT forming catalyst supporting body, a rod-like member that has a diameter less than the diameter of the space defined by the hollow-core electrolyte membrane. When the electrode catalytic layer (the cathode or the anode) is formed on the outer face of the hollow-core electrolyte membrane, a sheet-like or plate-like member may be preferably used as the base body for the CNT forming catalyst supporting body.

According to the first embodiment of the invention, the CNT forming catalytic metal formed of Fe is uniformly deposited onto the base body so that the thickness of the CNT forming catalytic metal is a desired value (4 nm). Thus, the CNT forming catalyst supporting body is formed.

Next, the carbon nanotube forming step is performed. More specifically, the CNT forming catalyst supporting body is heated, under vacuum, to a predetermined temperature at which the carbon nanotubes are appropriately formed, and source gas (e.g., hydrocarbon gas, alcohol gas, and hydrogen gas) is supplied to the CNT forming catalyst supporting body, whereby the carbon nanotubes are formed on the CNT forming catalyst supporting body. The diameter of the carbon nanotube is adjusted, for example, by adjusting the supply flow amount of the material gas, the reaction temperature of the material gas and the retention temperature, changing the size (the grain diameter) of the CNT forming catalytic metal particle, or further heating the carbon nanotubes at a temperature of 1500° C. to 1850° C. The diameter of the carbon nanotube is adjusted also by controlling the properties of the source gas based on the shape such as the layer structure, the diameter, and the length, and the orientation of the carbon nanotube to be formed, for example, by ionizing the material gas using; for example, an ion gun.

It is possible to efficiently form carbon nanotubes each of which has a diameter of equal to or greater than 200 μm by causing the source gas to flow on the surface of the CNT forming catalyst supporting body at a flow rate of equal to or higher than 2 mm per second (2 mm/sec).

Preferably, the temperature of the CNT forming catalyst supporting body is equal to or higher than 400° C. when the material gas is supplied thereto. If the temperature of the CNT forming catalyst supporting body is equal to or higher than 400° C. when the material gas is supplied thereto, it is possible to form the carbon nanotubes at a speed at the mass production level, and to stably form the carbon nanotubes that are uniform in diameter, length, and orientation. Especially, if the temperature of the CNT forming catalyst supporting body is 500° C. to 1000° C., it is possible to form the homogeneous carbon nanotubes more efficiently. Preferably, the ambient pressure under vacuum in the carbon nanotube forming step is approximately 10⁻³ Pa to approximately 10 Pa.

Examples of the source gas include hydrocarbon gas, alcohol gas, and hydrogen gas. More specifically, at least one of hydrocarbon gas and alcohol gas may be used. Alternatively, at least one of hydrocarbon gas and alcohol gas, and at least one type of hydrogen gas selected from various types of hydrogen gases (gasificated, if necessary) may be both used. As the hydrocarbon component of the hydrocarbon gas, hydrocarbon having a carbon number of 1 to 6 (e.g., methane, ethane, acethylene, or benzene) may be used. As the hydrocarbon gas or the alcohol gas, for example, methanol, or ethanol may be used. When the source material is in the liquid state or the solid state, the source material may be brought into the gaseous state in advance, and then supplied to the CNT forming catalyst supporting bodies. When the source gas is the mixture of the hydrocarbon gas or the alcohol gas gas and the hydrogen gas, the mixture ratio (between the hydrocarbon gas or the alcohol gas and the hydrogen gas) is preferably 1 to 1 (1:1)to 1 to 20 (1:20) (partial pressure ratio or flow ratio).

After the carbon nanotube forming step is completed, the post-processing step is performed on the carbon nanotubes formed in the carbon nanotube forming step and the CNT forming catalyst supporting body on which the carbon nanotubes are formed, when required. The post-processing step is performed as follows. For example, the diameter of each tube is adjusted by further heating the carbon nanotubes at a temperature of 1500° C. to 1850° C. The end of each tube is opened by, for example, heating the formed carbon nanotubes in the air at a temperature of 500° C. to 600° C. (the air oxidation process), or performing the acid treatment using, for example, a hydrochloric acid or aqua regalis. In the acid treatment, in addition to the process for opening the end of each tube, the process for removing the CNT forming catalytic metal particles, which is performed after the carbon nanotubes are formed, the process for removing the soot, for example, amorphous carbon adhering to the carbon nanotubes, etc. may be performed.

Next, an example of the method for forming the cell module 10 will be described with reference to FIGS. 1 to 3.

First, the tubular fluorine ion-exchange resin membrane 11 is prepared. Then, the electrode catalyst supporting step, in which the platinum (Pt) particles are caused to be supported on the carbon nanotubes formed on the CNT forming catalyst supporting body, and the transfer step, in which the carbon nanotubes, on which the platinum (Pt) particles are supported, are transferred to the fluorine ion-exchange resin membrane 11, are performed, whereby the cell module 10 is formed. When necessary, the application step, in which a proton-conducting substance is provided on each carbon nanotube 31, and a water-repellent material is further provided on the proton-conducting substance provided on each carbon nanotube 31, may be performed between the electrode catalyst supporting step and the transfer step, or after the transfer step.

In the electrode catalyst supporting step, the electrode catalytic metal (Pt) particles 32 are caused to be supported on the carbon nanotubes 31 formed on the CNT forming catalyst supporting body. The platinum (Pt) particles are caused to be supported on the surfaces of the carbon nanotubes 31 by either the wet process or the dry process. In the wet process, preferably, a solution, obtained by dissolving an appropriate amount of a platinum chemical containing a chloroplatinic acid or a platinum nitric acid into alcohol such as ethanol, is applied onto the carbon nanotunbes 31, and then the carbon nanotubes 31 with the solution applied thereon is heated in the hydrogen atmosphere at a temperature of equal to or higher than 150° C. The solution is appropriately applied onto the carbon nanotubes 31, for example, by soaking the carbon nanotubes 31 in the solution, or dropping or spraying the solution onto the outer face of the carbon nanotubes 31. In the dry process, preferably, the solution is applied onto the carbon nanotubes 31, for example, by the electronic beam evaporation method, the sputtering method, or the electrostatic coating method.

Next, the application step is performed, when required. In the application step, the Nafion layers 33, each of which has a thickness of approximately 10 nm, are formed by applying the Nafion solution (the proton-conducting substance) onto the carbon nanotubes 31 on which the platinum (Pt) particles are supported. In this case, the carbon nanotubes 31, on which the platinum (Pt) particles are supported and the Nafion layers 33 are formed, are transferred to the fluorine ion-exchange resin membrane 11 in the transfer process performed later.

When the application step is performed, preferably, the Nafion layers 33 are formed as described above, and the PTFE layers 34 are further formed by applying a polytetratluoroethylene (PTFE: a water-repellent material) solution onto the Nation layers 33. In this case, the carbon nanotubes 31, on which the platinum (Pt) particles are supported and the Nation layers 33 and the PTFE layers 34 are formed, are transferred to the fluorine ion-exchange resin membrane 11 in the transfer step performed later.

In the application step, the Nafion layers 33 and the PTFE layers 34 may be formed using the Nation solution (the solution containing the proton-conducting substance) and the PTFE solution (the solution containing the water-repellent material), respectively, by a known process, for example, the coating process or the soaking process. It is particularly preferable to employ the soaking process, because the solutions are uniformly applied onto the surface of each of the fine nanotubes.

In the first embodiment of the invention, Nation is used as the proton-conducting substance. The Nation polymer is dissolved in the solution in advance, and the solution is applied onto carbon nanotubes, and the carbon nanotubes with the solution applied thereon are dried, whereby the Nation layers 33, namely, the proton-conducting substance layers 33 are formed. However, the proton-conducting substance layers 33 may be made of another substance. Also, the proton-conducting substance layers 33 may be formed by another process. For example, in the application step, the proton-conducting substance layers 33 may be formed in the following manner. The solution containing a styrensulfonic acid monomer is prepared instead of the Nafion solution, a polymer composition solution, obtained by adding additives such as a polymerization initiator selected from various types of polymerization initiators to the solution containing a styrensulfonic acid monomer when required, is used, the solution is applied to the CNT forming catalyst supporting body on which the carbon nanotubes 31 are formed, the carbon nanotubes 31 with the solution applied thereon are dried when required, and proton-conducting substance layers 33 are polymerized by irradiating radioactive ray such as ultraviolet or heating. The proton-conducting substance layers 33 thus formed on the surfaces of the carbon nanotubes 31 have excellent adhesion. Preferably, a solution containing the water-repellent material is applied onto the proton-conducting substance layers 33 to form the water-repellent layers 34.

In the transfer step, the carbon nanotubes 31, on which the platinum (Pt) particles are supported, are transferred from the CNT forming catalyst supporting body to the fluorine ion-exchange resin membrane 11. In the transfer step, the carbon nanotubes 31, formed on the CNT forming catalyst supporting body, are arranged so that the ends of the carbon nanotubes 31, which do not contact the CNT forming catalyst supporting body, contact the fluorine ion-exchange resin membrane 11. Then, the CNT forming catalyst supporting body and the fluorine ion-exchange resin membrane 11 are heated or pressurized to be formed into an assembly. After this, the CNT forming catalyst supporting body is removed from the assembly, whereby the carbon nanotubes 31 are transferred to the fluorine ion-exchange resin membrane 11.

The CNT forming catalyst supporting body and the fluorine ion-exchange resin membrane 11 may be heated or pressurized, for example, by the hot press method in which a pair of hot plates, with which pressure is applied, is used. Preferably, the CNT forming catalyst supporting body and the fluorine ion-exchange resin membrane 11 are heated at a temperature of 110° C. to 130° C. or pressurized at a pressure of 1 MPa to 2 MPa, because the The CNT forming catalyst supporting body and the fluorine ion-exchange resin membrane 11 are properly assembled with each other at a temperature or a pressure in the above-mentioned range.

The step, in which the carbon nanotubes 31 are transferred to the inner face of the tubular fluorine ion electrolyte 11 according to the first embodiment of the invention, is performed as follows. The carbon nanotubes 31 are formed on the rod-like base body having the outer diameter less than the inner diameter of the tubular fluorine ion-exchange resin membrane 11, the rod-like base body is inserted into the space defined by the fluorine ion-exchange resin membrane 11, the fluorine ion-exchange resin membrane 11 is pressed to the rod-like base body, and then heat is applied when required. Thus, the carbon nanotubes are transferred to the fluorine ion-exchange resin membrane 11.

The step, in which the carbon nanotubes are transferred to the outer face of the tubular fluorine ion-exchange resin membrane 11, is performed as follows. First, the carbon nanotubes are formed on the sheet-like base body. The sheet-like base body is wound around the fluorine ion-exchange resin membrane 11 while a pressure is applied. In this case, the face of the sheet-like base body, on which the carbon nanotubes are formed, contacts the fluorine ion-exchange resin membrane 11. Heat is applied when required. Thus, the carbon nanotubes are transferred to the fluorine ion-exchange resin membrane 11.

After the CNT forming catalyst supporting body and the fluorine ion-exchange resin membrane 11 are heated or pressurized, the CNT forming catalyst supporting body is removed, whereby transfer of the carbon nanotubes is completed. Performing such transfer step makes it possible to bond the carbon nanotubes 31 onto the fluorine ion-exchange resin membrane 11 while the orientation of the carbon nanotubes 31, established when the carbon nanotubes 31 are formed, is maintained at substantially the same level. Accordingly, if the carbon nanotubes 31 are formed in the carbon nanotube forming step so as to be substantially perpendicular to the catalyst supporting face of the CNT forming catalyst supporting body, transferring these carbon nanotubes 31 to the fluorine ion-exchange resin membrane 11 makes it possible to form linear carbon nanotubes 31 on the fluorine ion-exchange resin membrane 11 so that the carbon nanotubes 31 extend substantially perpendicularly from the fluorine ion-exchange resin membrane 11. As the technology for causing the carbon nanotubes 31 to extend substantially perpendicularly from the fluorine ion-exchange resin membrane 11, the method described in Japanese Patent Application No. 2002-51391 or “the method for substantially perpendicularly orienting carbon nanotubes by transferring the carbon nanotubes synthesized on a base plate to a thermoplastic material” may be employed.

To efficiently obtain electricity from the thus formed cell module 10, the anode-side collecting member 21 and the cathode-side collecting member 22 are fitted to the cell module 10. In the fitting step, preferably, the conductive adhesive agent 35 is used to increase adhesion and electric connection between the cell module 10 and the collecting members 21, 22.

Before the anode-side collecting member 21 and the cathode-side collecting member 22 are fitted to the cell module 10, the conductive adhesive agent 35 is applied onto the inner face of the anode 12 and the outer face of the cathode 13 of the cell module 10, or onto the anode-side collecting member 21 and the cathode-side collecting member 22. Such application of the conductive adhesive agent 35 may be performed in a known method.

The anode-side collecting member 21, which has a spring-wire shape and which has the outer coil diameter slightly greater than the inner diameter of the tubular fluorine ion-exchange resin membrane 11, is inserted into the space defined by the fluorine ion-exchange resin membrane 11 while the nominal outer diameter of the anode-side collecting member 21 is reduced by twisting the anode-side collecting member 21 in a direction in which the shaped anode-side collecting member 21 is wound. Then, the force for twisting the spring-wire shaped anode-side collecting member 21 is relaxed, whereby the anode-side collecting member 21 is fixed to the cell module 10 while the anode-side collecting member 21 applies a pressing force to the inner face of the cell module 10. Thus, the anode-side collecting member 21 and the anode 12 are electrically connected to each other.

Next, the fluorine ion-exchange resin membrane 11 with the anode-side collecting member 21 is inserted into the space defined by the cathode-side collecting member 22, which has a spring-wire shape and which has the inner coil diameter slightly less than the outer diameter of the tubular fluorine ion-exchange resin membrane 11, while the nominal diameter of the cathode-side collecting member 22 is increased by twisting the spring-wire shaped cathode-side collecting member 22 in the direction opposite to the direction in which the spring-wire shaped cathode-side collecting member 22 is wound. Then, the force for twisting the spring-wire shaped cathode-side collecting member 22 is relaxed, whereby the cathode-side collecting member 22 is fixed to the cell module 10 while the cathode-side collecting member 22 applies a pressing force to the outer face of the cell module 10. Thus, the cathode-side collecting member 22 and the cathode 13 are electrically connected to each other.

The anode 12 and the cathode 13 are formed in the inner side and the outer side in the tubular (hollow-core) cell module 10 described above, respectively. Therefore, electric power is generated by supplying the fuel gas containing hydrogen or the liquid fuel such as methanol to the inner side of the tubular cell module 10, and the oxidant gas containing oxygen to the outer side of tubular cell module 10. Alternatively, the cathode and the anode may be formed in the inner side and the outer side in the tubular cell module 10, respectively. In this case, electric power is generated by supplying the oxidant gas containing oxygen to the inner side of the tubular cell module 10, and the fuel gas containing hydrogen or the liquid fuel such as methanol to the outer side of tubular cell module 10.

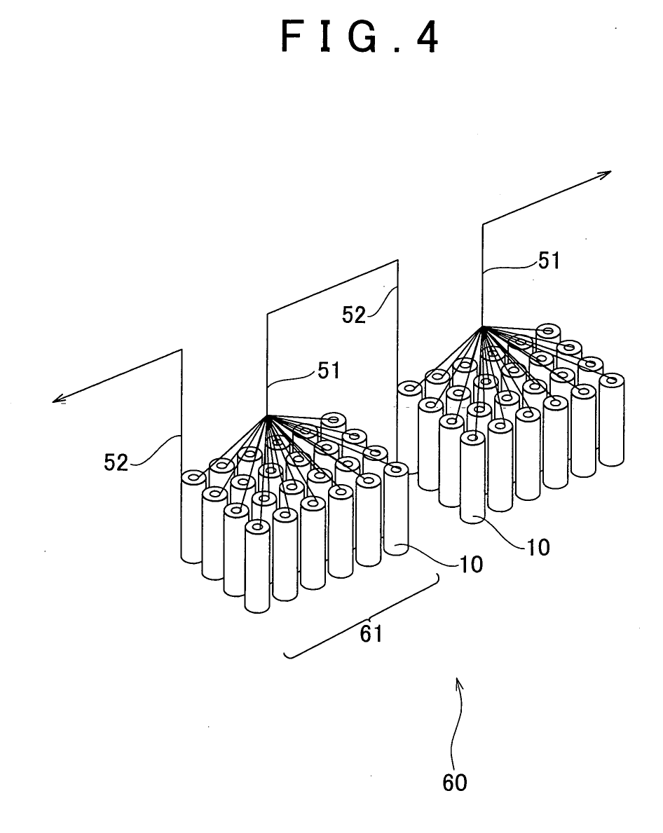

FIG. 4 is the view for describing a fuel cell 60 formed of multiple cell modules 10 formed in the steps described above, each of which is provided with the collecting members 21, 22. In order to actually use the fuel cell 60, a cell module assembly 61 is formed by connecting an appropriate number of cell modules 10 to each other in parallel, then an appropriate number of the cell module assemblies 61 are connected to each other in series.

In the cell module 10 according to the first embodiment of the invention, the electrode catalytic metal particles 32 are supported on the carbon nanotubes 31 arranged on the solid electrolyte membrane 11. Accordingly, the electrode catalytic metal particles 32 are highly densely supported on the carbon nanotubes 31 per unit electrode area, and the reaction gas supplied for the electric power generation easily comes close to the three-phase interfaces formed on the carbon nanotubes 31 to be uniformly dispersed. Accordingly, the electrode catalytic metal particles 32 supported on the carbon nanotubes 31 are efficiently used for the electrode reaction.

In the cell module 10 according to the first embodiment of the invention, the carbon nanotubes 31 are connected, at one ends, to the solid electrolyte membrane 11, and contact, at the other end, the collecting members 21, 22. An external surface pressure is not applied between the collecting members 21, 22 and the cell module 10. In addition, the contact area between the collecting members 21, 22 and the cell module 10 is small because the spring-wire shaped collecting members 21, 22 linearly contact the cell module 10. However, appropriate electric connection is maintained between the cell module 10 and the collecting members 21, 22.

According to the invention, even when the nanotubes made, for example, of nano-glass that has lower electric conductivity than that of carbon nanotubes are used, appropriate electric connection between the cell module and the collecting members is maintained. The reason for this may be estimated as follows. Microscopically, multiple nanotubes are formed between the solid electrolyte membrane and the collecting members so as to be substantially perpendicular to the solid electrolyte membrane and the collecting members. Also, the surfaces of the nanotubes may be used as appropriate water passages. The electrode catalysts, supported on the nanotubes and located near the collecting members, are supplied with ions from the surfaces of the nanotubes and supplied with the reaction gas from the gas phase, thereby causing electrode reaction. The generated electric charges are moved to the collecting members by a mechanism such as a hopping mechanism. Namely, forming reaction fields near the collecting members using the nanotubes enables the generated electric charges to immediately move to the collecting members, for example, by the hopping mechanism. It is, therefore, considered that appropriate electric connection is maintained between the cell module and the collecting members.

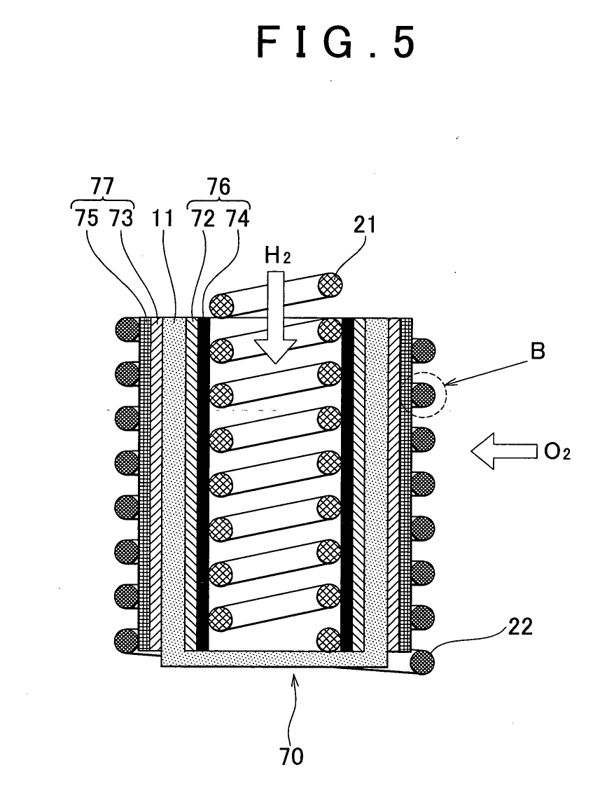

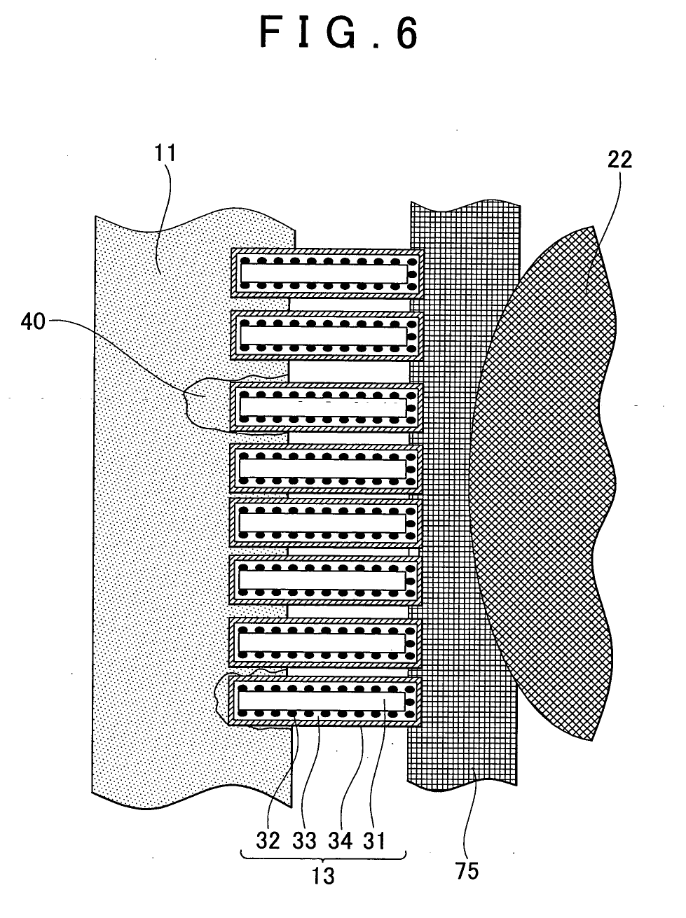

A cell module 70 according to a second embodiment of the invention will be described with reference to FIGS. 5 and 6. The cell module 70 according to the second embodiment differs from the cell module 10 according to the first embodiment in that diffusion layers are further formed in the inner side (the anode side) and the outer side (the cathode side) of the cell module, and the CNT electrodes (the anode and the cathode) are formed of the catalytic layers and the diffusion layers. In the second embodiment of the invention, the same fuel used in the first embodiment may be used for electric power generation. The same components as those in the first embodiment will be denoted by the same reference numerals, and the detailed description thereof will not be provided below.

In the second embodiment of the invention, as shown in FIG. 5, the cell module 70 is formed of the tubular fluorine ion-exchange resin membrane 11; an anode catalytic layer 72, which is formed on the inner face of the fluorine ion-exchange resin membrane 11 and which is formed by aligning the carbon nanotubes 31; a cathode catalytic layer 73, which is formed on the outer face of the fluorine ion-exchange resin membrane 11 and which is formed by aligning the carbon nanotubes 31; an anode diffusion layer 74 which is formed on the inner side of the tubular fluorine ion-exchange resin membrane 11 with the anode catalytic layer 72 interposed therebetween; and a cathode diffusion layer 75 which is formed on the outer side of the tubular fluorine ion-exchange resin membrane 11 with the cathode catalytic layer 73 interposed therebetween.

The anode diffusion layer 74 and the cathode diffusion layer 75 may be made of electric conducting porous bodies. For example, the anode diffusion layer 74 and the cathode diffusion layer 75 may be made of carbon cloth, carbon paper or carbon felt, or a material obtained by rendering carbon cloth, carbon paper or carbon felt water-repellent; porous metal formed of at least one type of metal selected from Ti, Al, Cu, Fe, Ni, Cr, Ta, Ti, Zr, Sm, and In or an alloy of these metals such as stainless steel, or a material obtained by coating porous metal formed of at least one type of these metals or the alloy of these metals with, for example, Au, Pt, or conductive resin.

Because the diffusion layers 74, 75 also serve as the structural members, the robustness of the cell module 70 improves, which increase the durability of the cell module 70.

Next, the method for forming the cell module 70 according to the second embodiment of the invention will be described below. First, the tubular anode diffusion layer 74 is formed. Then, the nanotubes 31 are transferred to the outer face of the anode diffusion layer 74. Thus, a diffusion layer/nanotube layer intermediary body is formed. The solid electrolyte membrane 11 is formed on the outer face of the diffusion layer/nanotube layer intermediary body by applying a solution or bonding a solid membrane onto the outer face of the diffusion layer/nanotube layer intermediary body. Then, the nanotubes 31 are transferred to the outer face of the diffusion/layer nanotube layer intermediary body. After this, the cathode layer 75 is formed on the outer side of the diffusion layer/nanotube layer intermediary body.

In this manner, the cell module 70 according to the second embodiment of the invention is easily formed, because the tubular anode diffusion layer 74, which serves as the structural member, is formed initially, and the subsequent steps are performed on the outer side of the tubular anode diffusion layer 74.

In the cell module 70 according to the second embodiment of the invention, as shown in FIG. 6, the diffusion layers 74, 75 made of conductive material are formed on the catalytic layers 72, 73, respectively. Accordingly, the electric charges generated by the electrode reaction caused by the electrode catalytic metal particles easily reach the diffusion layers 74, 75, and further, the electric charges efficiently move from the conductive diffusion layers 74, 75 to the collecting members 21, 22, respectively. Therefore, appropriate electric connection is maintained between the cell module 70 according to the second embodiment of the invention and the collecting members 21, 22.

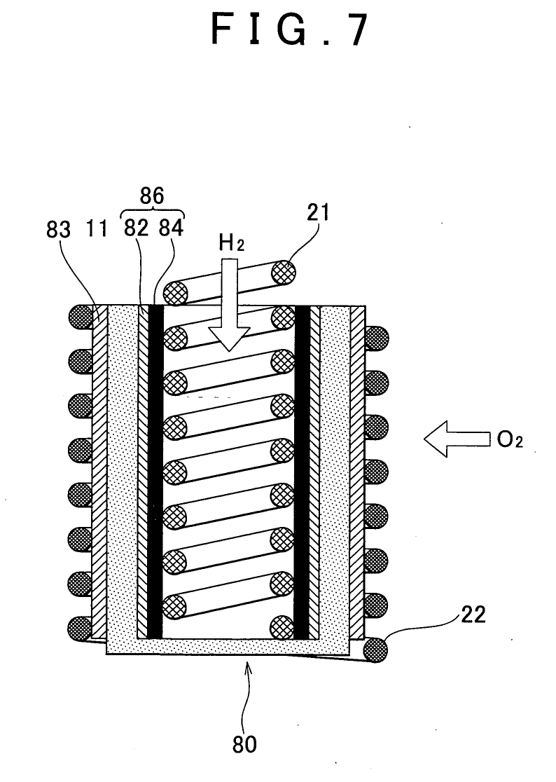

FIG. 7 is a cell module according to a first modified example of the embodiments of the invention. In this structure, the diffusion layer formed on the outer side of the fluorine ion-exchange resin membrane 11 in the second embodiment of the invention is not provided.

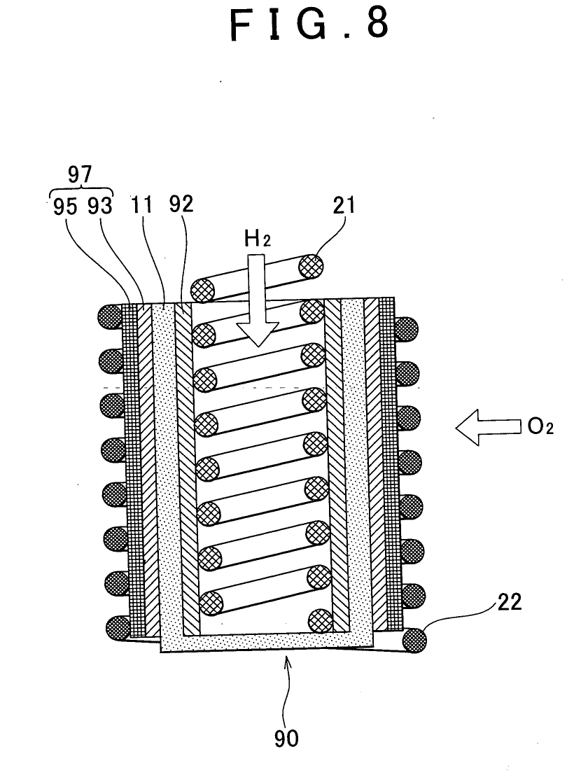

FIG. 8 is a cell module according to a second modified example of the embodiments of the invention. In this structure, the diffusion layer formed on the inner side of the fluorine ion-exchange resin membrane 11 in the second embodiment of the invention is not provided. In this case, a diffusion layer 95 to be formed on the outer side of the fluorine ion-exchange resin membrane 11 may be initially formed into a tubular shape. Then, the other layers may be formed on the inner side of the diffusion layer 95.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are examples, other combinations and configurations, including more, less or only a single element, are also within the spirit and scope of the invention.

1-21. (canceled)

22. A cell module for a fuel cell, comprising:
a hollow-core electrolyte membrane;
a pair of electrodes one of which is arranged on an inner face of the hollow-core electrolyte membrane and the other of which is arranged on an outer face of the hollow-core electrolyte membrane; and
a collecting member that faces the electrode, wherein
at least one of the electrodes arranged on the inner face and the outer face of the hollow-core electrolyte membrane includes linear nano-columnar bodies, which are oriented substantially perpendicularly toward the membrane surface of the hollow-core electrolyte, membrane and which are bonded, at one ends, to the membrane surface of the hollow-core electrolyte membrane,
in a region of the electrode, the electrode contacting the collecting member at the region, at least part of the nano-columnar bodies are arranged, and contact, at the other ends, to the collecting member,
electrode catalytic metal is dispersed and supported on surfaces of the nano-columnar bodies and in clearances between the nano-columnar bodies, and
proton-conducting substance is provided on the surfaces of the nano-columnar bodies.

23. The cell module for a fuel cell according to claim 22, wherein a length of each of the nano-columnar bodies is equal to or longer than 200 μm.

24. The cell module for a fuel cell according to claim 22, wherein pores having an average pore diameter of 5 nm to 100 nm are formed in the hollow-core electrolyte membrane.

25. The cell module for a fuel cell according to claim 22, wherein the electrode catalytic metal is formed of platinum or an alloy of platinum and another metal.

26. The cell module for a fuel cell according to claim 22, wherein a water-repellent material is further provided on the proton-conducting substance.

27. The cell module for a fuel cell according to claim 22, wherein a grain diameter of the electrode catalytic metal is equal to or less than an outer diameter of each of the nano-columnar bodies.

28. The cell module for a fuel cell according to claim 22, wherein a thickness of the proton-conducting substance is 1 μm to 70 μm.

29. A fuel cell comprising:
the cell module for a fuel cell according to claim 22.

30. A method for forming a cell module for a fuel cell, comprising:
an electrode catalyst supporting process in which electrode catalytic metal is supported on nano-columnar bodies formed on a nanotube forming catalyst supporting body;
a providing process which is performed after the electrode catalyst supporting process, and in which proton-conducting substance is further provided on the nano-columnar bodies supported on the nanotube forming catalyst supporting body;
a transferring process which is performed after the providing process and in which the nano-columnar bodies, on which the electrode catalytic metal is supported and the proton-conducting substance is provided, are transferred to at least one of an inner face and an outer face of a hollow-core electrolyte membrane, and the nano-columnar bodies are oriented such that the nano-columnar bodies are bonded, at one end, to the membrane surface of the electrolyte membrane so as to be substantially perpendicular to the membrane surface; and
a bonding process which is performed after the transferring process, and in which a collecting member is made to face the membrane surface of the electrolyte membrane, on which the nano-columnar bodies are arranged, and the nano-columnar bodies, which are bonded at one end to the electrolyte membrane, are bonded, at the other ends, to a contact portion of the collecting member by a conductive adhesive agent.

31. The method for forming a cell module for a fuel cell according to claim 30, wherein the nano-columnar bodies are nanotubes formed by causing source gas to flow on a surface of the nanotube forming catalyst supporting body at a flow rate of equal to or higher than 2 mm per second.

32. The method for forming a cell module for a fuel cell according to claim 30, wherein the electrode catalytic metal is supported on the nano-columnar bodies by a wet process or a dry process.

33. The method for forming a cell module for a fuel cell according to claim 30, wherein:
in the providing process, a water-repellent material is further provided on the proton-conducting substance, and
in the transferring process, the nano-columnar bodies, on which the water-repellent material is provided, are transferred.

34. The method for forming a cell module for a fuel cell according to claim 30, where, in the providing process, the proton-conducting substance is provided by a soaking process.

35. The method for forming a cell module for a fuel cell according to claim 30, wherein, in the providing process, a precursor of the proton-conducting substance is provided on the nano-columnar bodies, and then the proton-conducting substance is provided on the nano-columnar bodies by polymerizing the precursor of the proton-conducting substance.
